(19) United States
(12) Patent Application Publication
(10) Pub. No.: US 2014/0222663 A1
(43) Pub. Date: Aug. 7, 2014

(54) GROUP PAYMENT

(71) Applicant: KT CORPORATION, Gyeonggi-do (KR)

(72) Inventors: Jong-Han PARK, Seoul (KR); Dong-Wan KIM, Seoul (KR); Min-Gu LEE, Gyeonggi-do (KR); Ra-Woon CHOI, Seoul (KR)

(73) Assignee: KT CORPORATION, Gyeonggi-do (KR)

(21) Appl. No.: 14/175,166

(22) Filed: Feb. 7, 2014

(30) Foreign Application Priority Data
Feb. 7, 2013 (KR) 10-2013-0014120

(51) Int. Cl. G06Q 20/22

(52) U.S. Cl. CPC G06Q 20/29; G06Q 20/227
USPC 705/39

(57) ABSTRACT

The disclosure is related to a group payment service. For the group payment service, primary user equipment for a group payment may receive information on payment instruments from member user equipments upon generation of a predetermined event. The primary user equipment may generate group payment information based on the received payment instrument information transmitted from the member user equipments, information on a payment instrument stored in and selected by the primary user equipment, and payment information received from a payment terminal. The primary user equipment may transmit the generated group payment information to a service server for making a group payment.

### CROSS REFERENCE TO PRIOR APPLICATIONS

The present application claims priority under 35 U.S.C. §119 to Korean Patent Application No. 10-2013-0014120 (filed on Feb. 7, 2013), which is hereby incorporated by reference in its entirety.

### BACKGROUND

The present disclosure relates to making a payment using user equipment and, more particularly, to making a group payment using user equipment. A smartphone has various features including a near field communication (NFC) feature. Such NFC feature of the smartphone enables consumers to purchase goods or services from a merchant conveniently. For example, consumers can make a payment for purchasing goods or services using payment instruments stored in their smartphones (e.g., universal subscriber identity module (USIM) card) not only from stores but also from online shopping sites.

### SUMMARY

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present embodiment, a group payment may be made through user equipment having a touch screen based on a predetermined pattern of touch inputs.

In accordance with another aspect of the present invention, a group payment may be made through one user equipment by receiving payment instrument information from the others.

In accordance with at least one embodiment, a method may be provided for making a group payment by first user equipment. The method may include receiving, as a primary user equipment for a group payment, information on payment instruments from member user equipments upon generation of a predetermined event, generating group payment information based on the received payment instrument information transmitted from the member user equipments, information on a payment instrument stored in and selected by the primary user equipment, and payment information received from a payment terminal, and transmitting the generated group payment information to a service server for making a group payment.

The method may further include producing and displaying a graphic user interface that enables a user to set the first user equipment as one of a member user equipment and a primary user equipment and setting the first user equipment as the primary user equipment in response to a user input.

The method may further include producing and displaying a graphic user interface that enables a user to set the first user equipment as one of a member user equipment and a primary user equipment, setting the first user equipment as the member user equipment in response to a user input, selecting one of payment instruments stored in the first user equipment in response to a user input, and transmitting the selected payment instrument information to a primary user equipment upon generation of the predetermined event. The predetermined event may include detecting the primary user equipment located in a predetermined distance and receiving a user input that activates a group payment service application installed in the first user equipment.

The receiving may include receiving a tagging input made by each member user equipment and receiving payment instrument information through near field communication.

The payment instrument information includes information on a name of a payment instrument, a payment instrument account number, an expiration date, a security code, a pin number, and an Internet address of an associated financial transaction server.

The generating group payment information may include obtaining payment information from a payment terminal upon generation of the predetermined event.

The payment terminal information may include information on a merchant, a payment amount, a purchasing date and time, a purchased good or a service.

The generating group payment information may be initiated by receiving a dragging input that drags payment instrument icons to a group payment icon.

The generating group payment information may include receiving a user selection input for selecting at least one of the payment instrument information received from the member user equipments, receiving a user selection input for selecting one of payment instruments stored in the primary user equipment, and generating a group payment request to include the selected payment instrument information of the member user equipments, the selected payment instrument information of the primary user equipment, the payment information from the payment terminal, and a default splitting rate.

The generating group payment information further may include displaying a graphic user interface for enabling the user to set a splitting rate for the group payment, setting the splitting rate for the group payment in response to a user input received through the graphic user interface, and including the splitting rate into the group payment request.

In response to the group payment request, the service server may be configured to request a corresponding financial transaction server to process an each split portion of a payment amount with an associated payment instrument based on information included in the group payment request, to receive a processing result from the corresponding financial transaction server, and to transmit the received processing result to the primary user equipment, the member user equipments, and the payment terminal.

In accordance with at least one embodiment, user equipment may be provided for a group payment service. The user equipment may be configured to receive, as a primary user equipment for a group payment, information on payment instruments from member user equipments upon generation of a predetermined event, to generate group payment information based on the received payment instrument information transmitted from the member user equipments, information on a payment instrument stored in and selected by the primary user equipment, and payment information received from a payment terminal, and to transmit the generated group payment information to a service server for making a group payment.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 illustrates a group payment service in accordance with at least one embodiment;

FIG. 2 illustrates registration for a group payment service in accordance with at least one embodiment;

FIG. 3 illustrates producing and displaying a payment instrument icon in accordance with at least one embodiment;

FIG. 4 illustrates performing a group payment in accordance with at least one embodiment;

FIG. 5 illustrates a graphic user interface of user equipment for initiating a group payment procedure in accordance with at least one embodiment;

FIG. 6 illustrates a graphic user interface of member user equipment for selecting and transmitting payment instrument information from member user equipment to primary user equipment in accordance with at least one embodiment;

FIG. 7 illustrates a graphic user interface of primary user equipment for setting up information on a group payment in accordance with at least one embodiment;

FIG. 8 illustrates obtaining information from a payment terminal in accordance with at least one embodiment;

FIG. 9 illustrates a graphic user interface for making a group payment by transmitting payment instrument information to a service server in accordance with at least one embodiment; and

FIG. 10 illustrates user equipment for a group payment in accordance with at least one embodiment.

### DESCRIPTION OF EMBODIMENTS

Reference will now be made in detail to embodiments of the present invention, examples of which are illustrated in the accompanying drawings, wherein like reference numerals refer to like elements throughout. The embodiments are described below, in order to explain the present invention by referring to the figures.

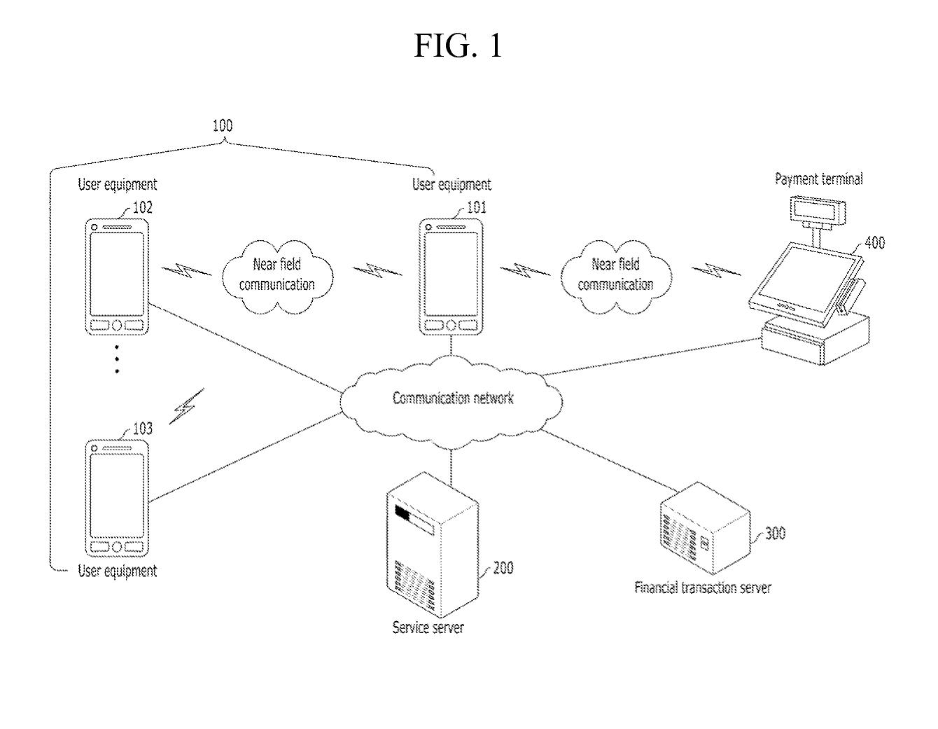

In accordance with at least one embodiment, a payment for a group of individuals is made through one user equipment by collecting information of payment instruments from others. Hereinafter, overall operation of such a group payment service will be described with reference to FIG. 1.

FIG. 1 illustrates a group payment service in accordance with at least one embodiment.

Referring to FIG. 1, a group payment service may be provided through a plurality of user equipment 100 in connection with service server 200, financial transaction server 300, and payment terminal 400 in accordance with at least one embodiment. Particularly, each one of user equipment 101 to 103 may be set as member user equipment or primary user equipment for a group payment service. The primary user equipment (e.g., user equipment 101) collects information on payment instruments from the member user equipment (e.g., user equipment 102 and 103) and obtains payment information from payment terminal 400. The primary user equipment transmits the collected payment instruments to service server 200 with a group payment request. In response to the group payment request, service sever 200 splits a payment by the number of members with a predetermined rate and processes each split portion of the payment using the respective collected payment instruments of the members in connection with corresponding financial transaction server 300. As shown, user equipment 100, payment server 200, financial server 300, and payment terminal 400 (e.g., POS) are coupled through a communication network.

User equipment 100 may be an electronic device having processing power and communication capability. For mobile and data communication, user equipment 100 may include a mobile communication circuitry module, an Internet communication circuitry module, and a short distance communication circuitry module. For example, user equipment 100 may include a personal computer (PC), a smartphone, a laptop computer, a personal digital assistance (PDA), and a portable multimedia player (PMP). The present invention, however, is not limited thereto.

Particularly, user equipment 100 may include various types of short distance communication circuitries. For example, user equipment 100 includes circuitries for near field communication (NFC), Bluetooth communication, radio frequency identification (RFID) communication, infrared data communication, and acoustic communication. NFC is a technology for portable electronic devices to establish radio communication with each other by touching them together or bringing them into proximity, usually no more than a few inches. For example, NFC is related to international standards including ISO/IEC 1443 proximity-card standard (e.g., contactless card or RFID standards), User equipment 100 communicates with each other through peer to peer communication using a NFC circuitry module thereof. For example, using such NFC circuitry module, user equipment 100 exchange data up to about 424 kbps within a maximum distance of about 10cm. User equipment 100 transmits and receives any type of data through NFC circuitry modules, such as text, image, moving pictures, and voice.

In accordance with at least one embodiment, user equipment 100 obtains information on payment instruments stored therein or receives information on payment instruments from other user equipment through near field communication. Based on the payment instrument information, user equipment 100 produces and displays corresponding payment instrument icons on a touch screen thereof. Furthermore, user equipment 100 also receives payment information from payment terminal 400 through near field communication, produces a payment terminal icon, and displays the payment terminal icon on the touch screen thereof. When user equipment 100 receives a predetermined pattern of a touch input made in association with a payment instrument icon and a payment terminal icon, user equipment 100 requests service server 200 to make a payment by transmitting payment instrument information and payment information corresponding to the payment instrument icon and the payment terminal icon.

For example, user equipment 100 obtains information on various types of digital payment instruments from an associated server when the digital payment instruments are issued at user equipment 100. The digital payment instruments may include a credit card, a debit card, a gift card, a store card, and a bank account for wired transfer. That is, the digital payment instrument may be a digital version of a payment card such as a credit card, a debit card, a bank account, a gift card, and so forth. User equipment 100 produces credit card icons, debit card icons, or bank account icons based on the obtained information and displays the produced icons on a touch screen.

Furthermore, user equipment 100 communicates with payment terminal 400 having a NFC circuitry module and receives payment information from payment terminal 400 through near field communication. In this case, user equipment 100 produces and displays a payment terminal icon on the touch screen. When user equipment 100 receives a dragging input from a user for dragging one of the payment instrument icons to the payment terminal icon or for dragging the payment terminal icon to the payment instrument icon, user equipment 100 requests service server 200 to make a payment based on information associated with the payment instrument icon and the payment instrument icon.

In accordance with at least one embodiment, user equipment (e.g., 101 as primary user equipment) receives information on payment instruments from other user equipment (e.g., 102 and 103 as member user equipment) when user equipment 101 touches other user equipment 102 or 103 (e.g., tagging input) in order to initiate a group payment operation. As the primary user equipment for the group payment service, user equipment 101 produces member's payment instrument icons based on the received payment instrument information and a group payment icon for setting up a group payment with the received information on payment instruments of member user equipment 102 and 103.

In accordance with at least one embodiment, a group payment service may enable a group of individuals to make a payment together using user equipment by collecting information on payment instruments from each individual, splitting a payment amount with a predetermined rate, and processing each one of split payment amounts using the collected payment instruments, respectively. For example, three friends have a dinner together at a restaurant and they want to pay the dinner using the group payment service. In this case, first user equipment 101 (e.g., first friend) collects information on payment instruments from second and third user equipment 102 and 103 (e.g., second and third friend). That is, second and third friends select one of payment instruments and transmit information on the selected payment instrument to first user equipment 101. First user equipment 101 produces icons each associated with the received payment instrument and displays the produced icons. First user equipment 101 further produces and displays a group payment icon for making a group payment for the dinner.

When first user equipment 100 receives a dragging input for dragging the payment instrument icons of all group payment members into the group payment icon, first user equipment 101 generates group payment information and complete setting of corresponding group payment icon. When first user equipment 101 receives a dragging input for dragging the group payment icon to a payment terminal icon, first user equipment 101 transmits group payment information to service server 200 and request to make a group payment based on the transmitted group payment information.

Such a group payment operation may be performed through application software installed and executed in each user equipment in connection with service server 200. Such group service application software may be downloaded from service server 200 when user equipment 100 registers at service server 200 for the group payment service. The group service application software may be executed and the group payment service may be initiated based on the execution of the group service application software upon the generation of a predetermined event. The predetermined event may include activation of an associated icon displayed within a default graphic user interface such as a home screen and detection of other user equipment through near field communication.

Service server 200 is a computing system of a service provider for providing a group payment service. For example, service server 200 may be a server of a communication service provider. Service server 200 is coupled to user equipment 100 through a communication network. Furthermore, service server 200 may be coupled to payment terminal 400 and financial transaction server 300 through a communication network.

Service server 200 may receive a registration request from user equipment 100 for a group payment service and register user equipment 100 in response to the registration request. That is, service server 200 may receive information on user equipment 100 and payment instruments thereof with the registration request from user equipment 100 and store and manage the received information. Furthermore, service server 200 may provide information to user equipment 100 for the group payment service, such as eligible payment instruments for the group payment service. Service server 200 may provide application software for the group payment service to user equipment 100.

Service server 200 may receive a group payment request from user equipment 100 and perform a process for making a group payment in connection with financial transaction server 300 in response to the group payment request. For the group payment process, i) service server 200 performs an authentication process for authenticating user equipment 100 and ii) service server 300 relays connection with financial transaction server 300 in order for user equipment 100 to produce a bank icon.

Financial transaction server 300 may be a computing system of a financial institution that issues payment instruments and processes financial transaction between a consumer and a merchant based on a payment made through the issued payment instruments. For example, financial transaction server 300 may be a computing system of a bank or a credit card company. Financial transaction server 300 receives a payment request from service server 200 with payment instrument information (e.g., a payment instrument of corresponding member user equipment) and payment information (e.g., a split payment amount and a merchant). In response to the payment request, financial transaction server 300 performs financial transaction between a merchant and a consumer (e.g., a user of corresponding user equipment).

For convenience and ease of understanding, only one financial transaction server 300 is illustrated in FIG. 1. The present invention, however, is not limited thereto. For example, service server 200 may transmit a plurality of payment requests to multiple financial transaction servers associated with the plurality of payment requests respectively.

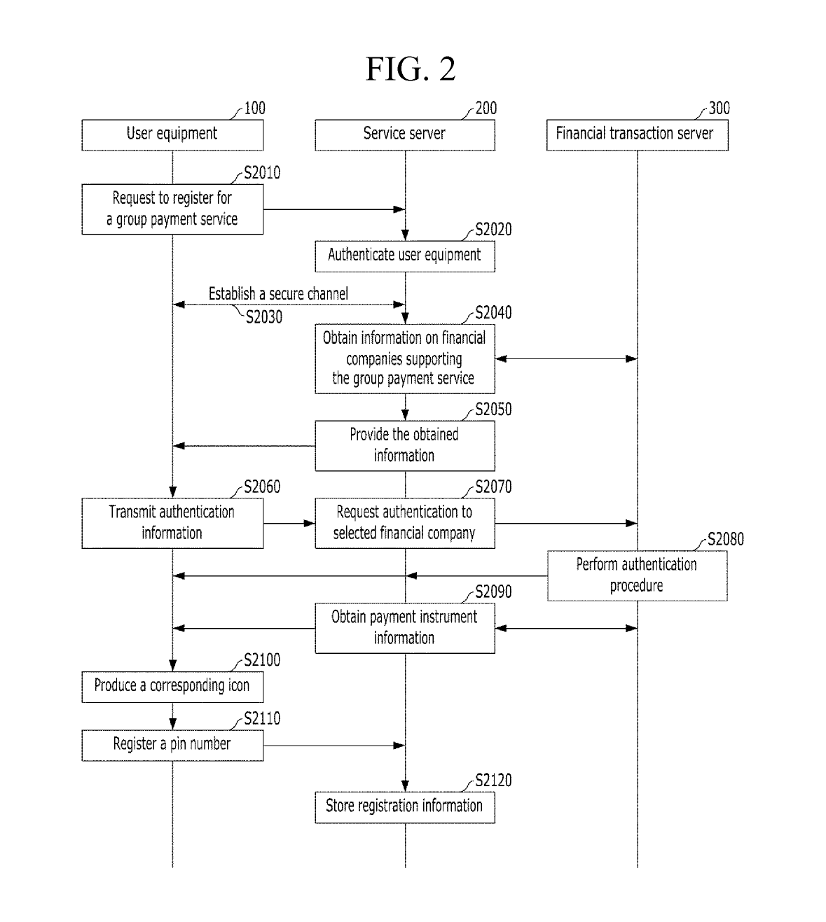

As described above, user equipment 100 registers at service server 200 for the group payment service in accordance with at least one embodiment. Hereinafter, such registration operation will be described with reference to FIG. 2.

FIG. 2 illustrates registration for a group payment service in accordance with at least one embodiment.

Referring to FIG. 2, a registration request is transmitted to service server 200 for a group payment service at step S2010. For example, user equipment 100 transmits a registration request for a group payment service to service server 200. Such a registration request may be initiated upon the generation of predetermined events. The predetermined events may include activation of an associated icon displayed within a default graphic user interface (e.g., home screen) of user equipment 100 or detection of other user equipment or payment terminal 400.

At step S2020, an authentication procedure is performed. For example, service server 200 performs an authentication procedure in response to the registration request. That is, service server 200 authenticates user equipment 100 based on identification information stored in a universal subscriber identity module (USIM), such as an international mobile subscriber identity (IMSI) or a USIM pin number. Furthermore, user equipment 100 may authenticate service 200 based on the information stored in the USIM.

At step S2030, a secure channel is established between user equipment 100 and service server 200. For example, as a result of performing the authentication procedure, user equipment 100 and service server 200 generate the same master session key at each authentication procedure. However, user equipment 100 and service server 200 generate a different mater session key at every authentication procedures. User equipment 100 and service server 200 use the generated master session key to establish a secure channel therebetween. That is, after the authentication procedure, the master session key is used to generate an Internet Protocol Security (IPSEC) encrypted channel between user equipment 100 and service server 200. Through such an IPSEC encrypted channel, user equipment 100 transmits data to or receives data from service server 200.

At step S2040, service server 200 obtains information on financial institutions that supports a group payment service to user equipment 100. For example, service server 200 inquires of each related financial transaction server (e.g., 300) whether a group payment service is eligible to be provided to user equipment 100. That is, service server 200 inquires of each financial institution whether a group payment service can be provided to user equipment 100 based on a USIM ID (e.g., IMSI or a telephone number).

At step S2050, service server 200 transmits the obtained information to user equipment 100. For example, service server 200 receives the inquiry result from each financial institution and provides the inquiry result to user equipment 100. That is, service server 200 provides the information on financial institutions eligible to provide the group payment service to user equipment 100. That is, service server 200 might transmit names of eligible credit card companies and eligible banks to user equipment 100.

Such registration operation including steps S2010 to S2050 may be initiated and performed in sequence or in parallel automatically upon the generation of the predetermined events. That is, user inputs may be not necessary to perform each step of the registration operation. The following operation steps might be performed in response to a predetermined user input.

At step S2060, user equipment 100 requests authentication to each one of service-eligible financial institutions. For example, user equipment 100 requests each one of the service-eligible financial institutions to authenticate user equipment 100 based on the obtained information. That is, user equipment 100 requests a financial transaction server (e.g., 300) of each service-eligible financial institution to authenticate user equipment 100 through service server 200. Particularly, user equipment 100 obtains an authentication certificate of a financial institution in response to a selection input from an associated user and receives an authentication pin number from a user. User equipment 100 transmits an authentication request to service server 200 with the authentication certificate and the authentication pin number. Service server 200 delivers the received authentication certificate and the authentication pin number to financial transaction server 300 with the authentication request. Service server 200 may store the received authentication certificate and the authentication pin number.

At step S2080, financial transaction server 300 performs an authentication procedure based on the authentication certificate and the authentication pin number of user equipment 100. For example, in response to the authentication request, financial transaction server (e.g., 300) of each service-eligible financial institution authenticates user equipment 100 based on the authentication certificate and the authentication pin number.

At step S2090, service server 200 obtains payment instrument information from financial transaction server 300. For example, as a result of the authentication, financial transaction server 300 transmits payment instrument information to service server 200. For example, service server 200 obtains information on a corresponding payment instrument such as a bank account number or a credit card number from a bank or a credit card company. Service server 200 provides the obtained payment instrument information to user equipment 100.

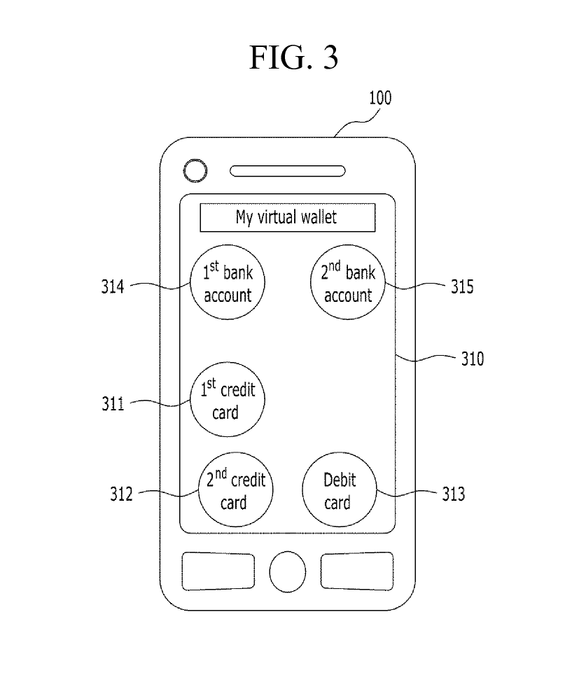

At step S2100, user equipment 100 produces and displays a payment instrument icon. For example, user equipment 100 receives the payment instrument information from service server 200. Based on the payment instrument information, user equipment 100 generates a corresponding payment instrument icon. In addition, user equipment 100 may receive selection inputs for selecting at least one of multiple payment instruments of the service-eligible financial institutions and generate payment instrument icons only for the selected payment instruments. Such generating operation will be described with reference to FIG. 3.

At step S2110, user equipment 100 receives a pin number for each one of the generated payment instruments and transmits the received pin number to service server 200. At step S2120, service server 200 receives the pin number of each one of the payment instruments and updates the registration data of user equipment 100 with the received pin number.

As described above, as a result of the registration operation, user equipment 100 obtains information on the service-eligible financial institutions and generates corresponding payment instrument icons based on the obtained information. Such operation will be described with reference to FIG. 3.

FIG. 3 illustrates producing and displaying a payment instrument icon in accordance with at least one embodiment.

Referring to FIG. 3, user equipment 100 receives information on service-eligible financial institutions from service server 200. Such information may include a name of a payment card, a payment card number, an expiration date, a security code, and so forth. Based on the such information, user equipment 100 generates icons such as 1^{st} bank account icon 314, 2^{nd} bank account icon 315, 1^{st} credit card icon 311, 2^{nd} credit card icon 312, and debit card icon 313. User equipment 100 also generates graphic user interface 310 for the group payment. User equipment 100 displays 1^{st} bank account icon 314, 2^{nd} bank account icon 315, 1^{st} credit card icon 311, 2^{nd} credit card icon 312, and debit card icon 313 within graphic user interface 310 as shown in FIG. 3.

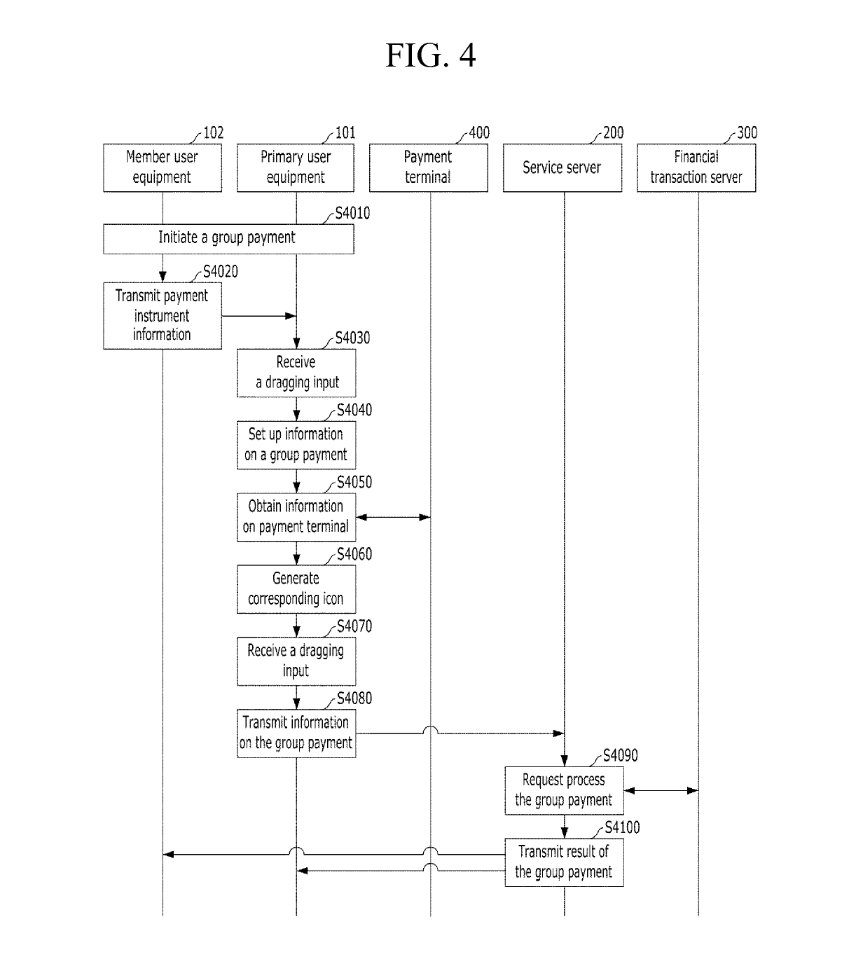

Upon the initiation of a group payment after registration, user equipment 101 collects payment instrument information from others and transmits the collected payment instrument information with own payment instrument information to service server 200. Service server 200 processes a group payment using the received payment instrument information. Hereinafter, such operation will be described with reference to FIG. 4 to FIG. 9. For convenience and ease of understanding, two user equipment 101 to 102 will be described as participating a group payment, but the present invention is not limited thereto. The group payment service in accordance with at least one embodiment may be applied without limitation of the number of user equipment participating the group payment.

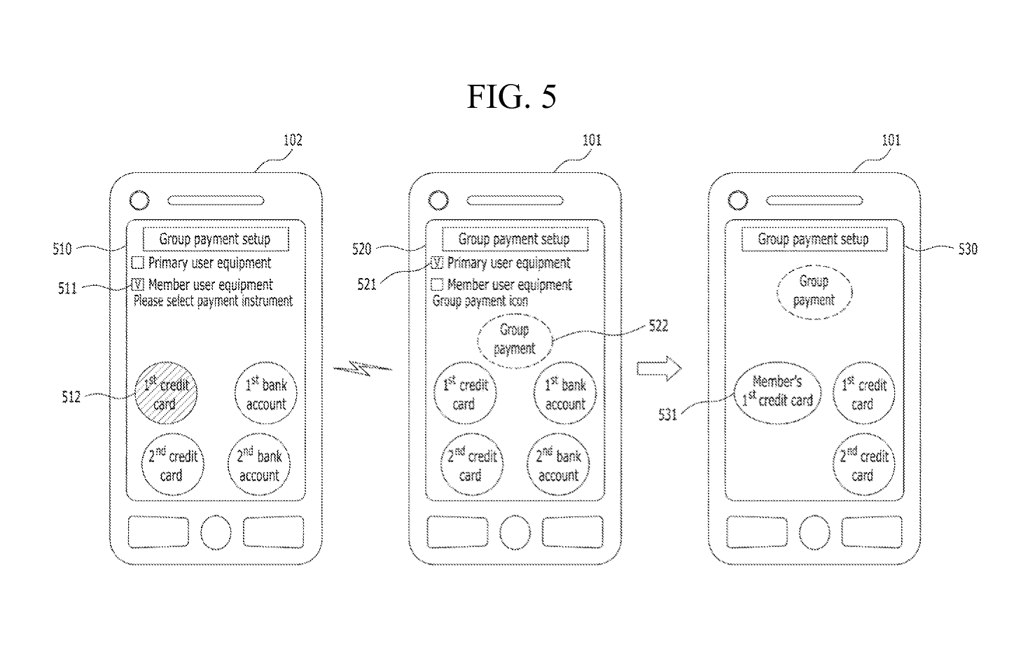

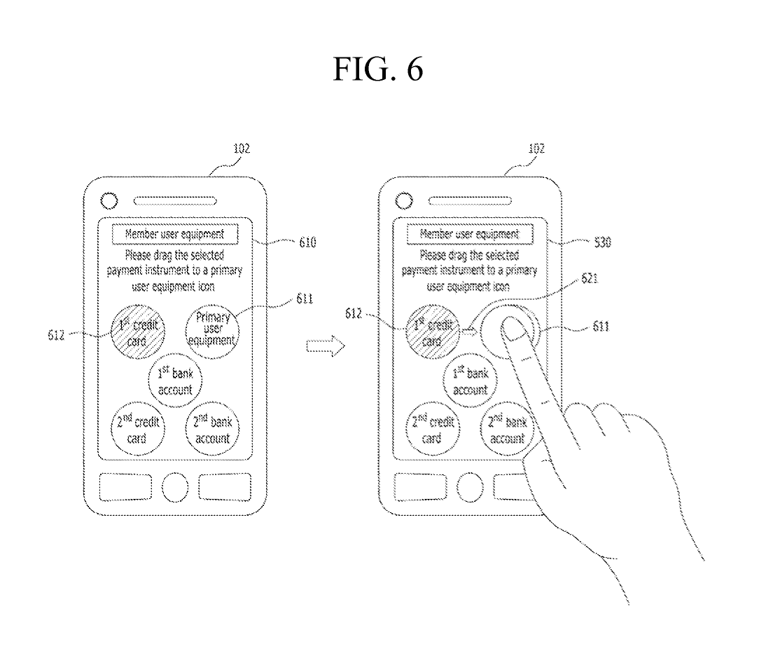

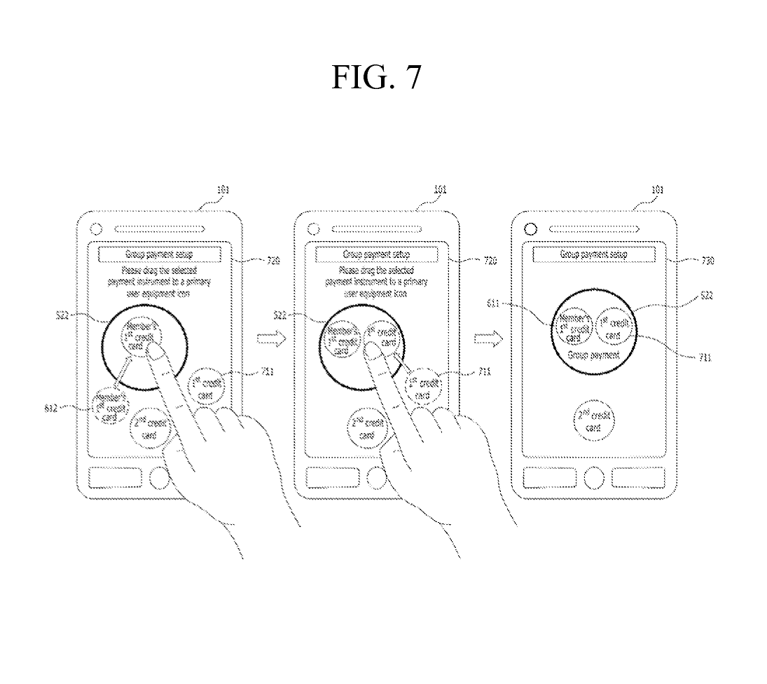

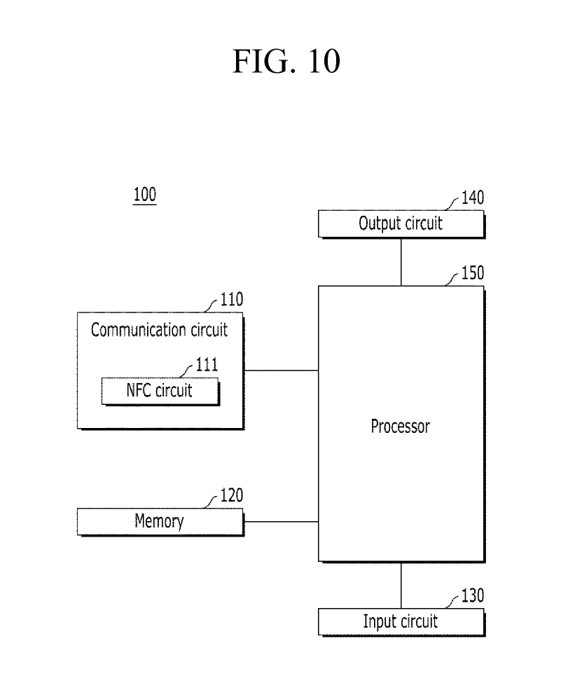

FIG. 4 illustrates performing a group payment in accordance with at least one embodiment. FIG. 5, FIG. 6, FIG. 7, and FIG. 9 illustrate graphic user interfaces of user equipment for a group payment in accordance with at least one embodiment.

Referring to FIG. 4, a group payment is initiated at user equipment 101 to 102 in connection with payment terminal 400, service server 200, and financial transaction server 300 at step S4010. For example, a group payment procedure may be initiated by a tagging input made between primary user equipment 101 and member user equipment 102 or by activating a predetermined icon for the group payment service displayed with a default graphic user interface (e.g., home screen). Upon the initiation of the group payment procedure, each user equipment produces and displays a graphic user interface for setting up a group payment on a display of each user equipment. As shown in FIG. 5, such a graphic user interface enables a user to select user equipment as primary user equipment or as member user equipment. The primary user equipment is user equipment that will collect payment instrument information from member user equipment and transmit a group payment request to service server 200. The member user equipment is user equipment that will transmit selected payment instrument information to the primary user equipment and allow the primary user equipment to make the group payment.

In addition, such a graphic user interface enables a user: i) to select own user equipment as member user equipment or as primary user equipment, ii) to select payment instrument information and to transmit the selected payment instrument information to the primary user equipment, and iii) receive payment instrument information from the member user equipment and produce a member payment instrument icon and a group payment icon.

For example, user equipment 101 will be described as the primary user equipment that will make a group payment for purchasing a good or a service on payment terminal 400 for an associated group. User equipment 102 will be described as the member user equipment that will transmit payment instrument information to the primary user equipment and allows the primary user equipment to pay a corresponding portion of a payment amount for purchasing a good or a service with other members.

Referring to FIG. 5, graphic user interface 510 of member user equipment 102 enables a user to set user equipment as member user equipment or as a primary user equipment, to select one of payment instruments to make a group payment, and to transmit information on the selected payment instrument to the primary user equipment. As shown in graphic user interface 510 of FIG. 5, user equipment 102 is set as the member user equipment by selecting corresponding selection box 511. Furthermore, a user might select one of payment instruments by selecting associated icon 512 thereof.

Referring to FIG. 5, graphic user interface 520 of primary user equipment 101 also enables a user to set user equipment as member user equipment or as primary user equipment. As shown, user equipment 101 is set as the primary user equipment by selecting corresponding selection box 521. After setting as the primary user equipment, primary user equipment 101 produces and displays group payment icon 522.

After member user equipment 102 selects a desired payment instrument, member user equipment 102 transmits the information on the selected payment instrument to primary user equipment 101. Primary user equipment 101 receives the selected payment instrument information from member user equipment 102 and produces and displays payment instrument icon 531 of member user equipment 102 on a display, as shown in graphic user interface 530 of FIG. 5.

At step S4020, member user equipment 102 transmits information on a selected payment instrument to primary user equipment 101 through short distance communication. For example, FIG. 6 illustrates transmitting information on a selected payment instrument from member user equipment to primary user equipment in accordance with at least one embodiment. Referring to FIG. 6, member user equipment 102 may obtain information on primary user equipment 101 from primary user equipment 101 through near field communication. Based on the obtained information, member user equipment 102 produces and displays primary user equipment icon 611 with other payment instrument icons including selected payment instrument 612 as shown in graphic user interface 610 of FIG. 6.

When member user equipment 102 receives dragging input 621 from an associated user for dragging selected payment instrument icon 612 to primary user equipment icon 611, member user equipment 102 transmits information on the selected payment instrument to primary user equipment 101 through near field communication.

Although the selected payment instrument information was described as being transmitted through NFC, the present invention is not limited thereto. In accordance with another embodiment, member user equipment 102 may transmit such selected payment instrument information to primary user equipment 101 through a mobile communication network or a data communication network.

Furthermore, the selected payment instrument information was described as being transmitted to primary user equipment 101, but the present invention is not limited thereto. In accordance with another embodiment, member user equipment 102 may transmit the selected payment instrument information to service server 200. In this case, service server 200 may transmit the received payment instrument information to primary user equipment 101. Primary user equipment 101 receives the payment instrument information, which is selected and transmitted by member user equipment 102, from service server 200. Upon the receipt of the payment instrument information, primary user equipment 101 produces and displays member payment instrument icon 531 as shown in graphic user interface 530 of FIG. 5.

At step S4030, primary user equipment 101 receives a user input that triggers setting up information on a group payment. For example, FIG. 7 illustrates a graphic user interface of primary user equipment for setting up information on a group payment in accordance with at least one embodiment. Primary user equipment 101 receives a dragging input that drags payment instrument icon 612 and payment instrument icon 711 to group payment icon 522, as shown in graphic user interface 710 of FIG. 7. Payment instrument icon 612 may be mapped to information on the payment instrument selected and transmitted from member user equipment 102 and payment instrument icon 711 may be mapped to information on a payment instrument stored in and selected by primary user equipment 101.

At step S4040, primary user equipment 101 generates group payment information. For example, upon the receipt of the dragging input, primary user equipment 101 obtains information on selected payment instruments including a payment instrument from member user equipment 102 and a payment instrument stored and selected by primary user equipment 101. Based on the obtained information, primary user equipment 101 may generate group payment information for the group payment. For example, the generated group payment information may include information on each payment instrument such as a name of a payment card, a payment card number, an expiration date, a security code, an Internet address of a corresponding financial transaction server, a split portion of a payment amount, and so forth.

Referring to FIG. 7, primary user equipment 101 produces graphic user interface 720 showing dragging member's 1^{st} credit card icon 612 and own 1^{st} credit card icon 711 into group payment icon 522 and produces graphic user interface 730 showing group payment icon 522 including member's 1^{st} credit card icon 612 and own 1^{st} credit card icon 711.

In addition, after showing group payment icon 522 including member's 1^{st} credit card icon 612 and own 1^{st} credit card icon 711, primary user equipment 101 may produce a graphic user interface for enabling a user to set supplementary information for the group payment operation. For example, such graphic user interface may enable a user to set a desired rate to split a payment amount among members, to set a split portion of a payment amount, and so forth.

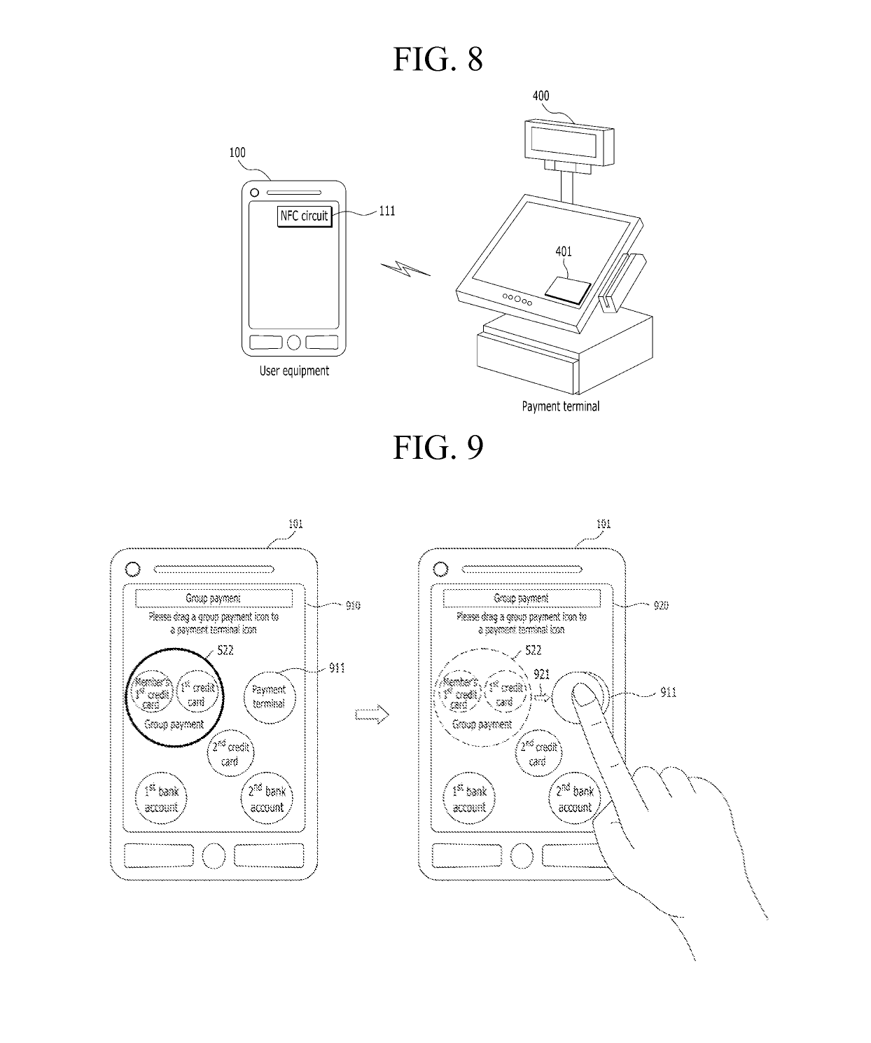

At step S4050, primary user equipment 101 obtains information on payment terminal 400 through near field communication. For example, FIG. 8 illustrates obtaining information from a payment terminal in accordance with at least one embodiment. Referring to FIG. 8, primary user equipment 101 may read information on payment terminal 400 from tag 401 of payment terminal 400 as shown in FIG. 8. In order to read such information, primary user equipment 101 may include tag reader 190. The information payment terminal 400 may include not only information on payment terminal but also payment information such as a payment amount for purchasing a good or a service.

At step S4060, primary user equipment 101 produces and displays a payment terminal icon based on the obtained information on payment terminal 400. For example, FIG. 9 illustrates a graphic user interface for making a group payment by transmitting payment instrument information to a service server in accordance with at least one embodiment. Referring to FIG. 9, primary user equipment 101 produces payment terminal icon 911as shown in graphic user interface 910 of FIG. 9.

At step S4070, primary user equipment 101 receives a user input for transmitting the group payment information. For example, primary user equipment 101 receives dragging input 921 that drags group payment icon 522 to payment terminal icon 910 as shown in graphic user interface 920 of FIG. 9. Such dragging input initiates transmission of the group payment information to service server 200.

At step S4080, primary user equipment 101 transmits the group payment information associated with group payment icon 522 to service server 200. For example, upon the receipt of the dragging input, primary user equipment 101 transmits the group payment information associated with group payment icon 522 and payment terminal information associated with payment terminal 400 to service server 200, as the group payment information. The group payment information may further include information obtained from tag 401 of payment terminal 400. Alternatively, service server 200 may obtain the payment information directly from payment terminal 400. That is, service server 200 may access payment terminal 400 using the payment terminal information received from primary user equipment 101 and obtain necessary information directly from payment terminal 400.

At step S4090, service server 200 requests financial transaction server 300 to process the group payment and receives a result from financial transaction server 300. Although such request is illustrated as being transmitted to one financial transaction server, the present invention is not limited thereto. For example, based on the group payment instrument, service server 200 requests financial transaction servers associated with the selected payment instruments of primary user equipment 101 and member user equipment 102 to process the group payment. That is, service server 200 may request a financial transaction server associated with a payment instrument selected and transmitted from member user equipment 102 to process a split portion of a payment amount of member user equipment 102 with the associated payment instrument. Service server 200 may request another financial transaction server associated with a payment instrument stored and selected by primary user equipment 101 to process a split portion of a payment amount of member user equipment 102 with the associated payment instrument. In response to request, the financial transaction servers may process the payment request and transmit the result thereof to service server 200.

At step S4100, service server 200 transmits the result to primary user equipment 101. For example, service server 200 may receive the result of processing the group payment from associated financial transaction servers. Service server 200 may transmit the received result to at least one of primary user equipment 101, member user equipment 102, and payment terminal 400.

FIG. 10 illustrates user equipment for a group payment in accordance with at least one embodiment.

Referring to FIG. 10, user equipment 100 may include communication circuit 110, memory 120, input circuit 130, output circuit 140, and processor 150. Although user equipment 100 is illustrated as including four constituent elements, the present invention is not limited thereto. For convenience and ease of understanding, a structure of user equipment 100 is simplified and only minimum elements thereof are illustrated in FIG. 10.

Communication circuit 110 may include at least one module for communicating with other party through a communication network. For example, wireless communication unit 110 may include any or all of a broadcasting signal receiving module, a mobile communication module, a wireless internet module, a short-distance communication module, and a location information module (e.g., GPS receiving module). The short-distance communication module may include a Bluetooth circuit, a radio frequency identification (RFID) circuit, an infrared data association (IrDA) circuit, an ultra-wideband (UWB) circuit, a Zigbee circuit, and a near field communication (NFC) module circuit. In accordance with at least one embodiment, such a short-distance communication module is used to transfer purchasing information from one user equipment to the other.

In accordance with at least one embodiment, communication circuit 110 includes NFC circuit 111 including a tag and a reader. NFC circuit 111 communicates with a NFC circuit of other devices such as user equipment 102 or payment terminal 400. That is, NFC circuit 111 receives information payment instruments selected and transmitted from other user equipment or receive payment information from payment terminal 400.

Memory 120 may be used as a data storage device of user equipment 100. Memory 120 may store information necessary for operating user equipment 100 and performing certain operations requested by a user. Such information may include any software programs and related data. Memory 120 may be a flash memory, hard disk, multimedia card micro memory, SD or XD memory, Random Access Memory (RAM), Static Random Access Memory (SRAM), Read-Only Memory (ROM), Programmable Read-Only Memory (PROM), Electrically Erasable Programmable Read-Only Memory (EEPROM), magnetic memory, magnetic disk, or optical disk, but is not limited thereto.

In accordance with at least one embodiment, memory 120 stores information related to a group payment service. For example, memory 120 may store information on payment instruments of user equipment 100 and information on payment instruments selected and transmitted from other user equipment. Such payment instrument information may include a name of a payment instrument, a payment card number, an expiration date, an associated icon image, an Internet address of an associated financial transaction server, a security number, a pin number, an authentication certificate, an authentication pin number, and so forth. Memory 120 may also store payment information from payment terminal 400. Such payment information may include information on a merchant, a payment amount, a purchasing date and time, a purchased good or service, and so forth. In addition, memory 120 may store group payment information. The group payment information may include information on members associated with a group payment, a total payment amount, a split rate, a split payment amount, and so forth.

Memory 120 may store identification information of user equipment 100. Such identification information may be stored in a memory of a USIM card included in user equipment 100. Such a USIM card may be an identification module circuit that stores information for authenticating a use right. That is, the USIM card stores as an international mobile subscriber identity (IMSI) or a USIM pin number. User equipment 100 may be authenticated based on the information stored in the USIM.

Input circuit 130 may be a user interface for receiving input (e.g., user commands) from a user. Input unit 130 may be realized in various types. For example, input circuit 130 may include a touch screen, a keyboard and/or a keypad, a mouse device and/or a touchpad. Input circuit 130 may further include a dome switch, a jog wheel, and a jog switch, but is not limited thereto. Particularly, with respect to the touch screen, user equipment 100 may be a full touch type smart phone. In this case, input circuit 130 may include several hardware key buttons and a touch screen. The hardware key buttons may include a hold key and a volume control button. The touch screen may be disposed on an upper surface of output circuit 150, but the present invention is not limited thereto.

In accordance with at least one embodiment, input circuit 130 receives a predetermined pattern of touch inputs for initiating various types of group payment operations. For example, input circuit 130 receives dragging inputs from a user to drag icons displayed on output circuit 140.

Output circuit 140 may be an output device for visually displaying information. For example, output circuit 140 may display image data (i.e., icons and information) produced or processed by central processor 150. Output unit 140 may receive the image data from processor 140 and display the received image data. The image data may be produced as a result of certain operations performed by any software programs installed in user equipment 100. For example, the image data may be data processed for displaying a graphic user interface produced by an operation system and applications, performed in user equipment 100. The applications may be referred to as “App”. Also, the image data may further include still images and moving images, produced or processed by central processor 180. For example, output circuit 140 may be a liquid crystal display (LCD) panel or an active-matrix organic light-emitting diode (AMOLED) panel, but the present invention is not limited thereto.

For example, output circuit 140 may display a graphic user interface showing payment instrument icons, a payment terminal icon, a group payment icon, and so forth. Furthermore, output circuit 140 may display a graphic user interface that enables a user to set user equipment as member user equipment or as primary user equipment, to select one of payment instrument icons, to set up a group payment, to transmit a payment request to service server 200, and so forth. In addition, output circuit 140 may further include output devices for outputting auditory sensing information and haptic sensing information. For example, output circuit 140 may include a speaker, an alarm circuit, and a haptic circuit.

Processor 150 may control overall operation of the constituent elements of user equipment 100. Particularly, processor 150 may perform operations necessary for driving the constituent elements of user equipment 100 in response to inputs received from a related user. In accordance with at least one embodiment, processor 150 may perform operations related to a group payment service.

Processor 150 may perform operations for authentication in connection with service server 200. For example, processor 150 performs an authentication procedure based on the USIM card with service server 200 and establishes a secure channel therebetween. Processor 150 may perform operations for registration. For example, processor 150 obtains payment instrument information from memory 120 or from other user equipment and produces corresponding payment instrument icons.

Processor 150 may perform operations for setting a group payment. For example, processor 150 performs operations for setting up user equipment 100 as member user equipment or as primary user equipment in response to a user input. In case of the member user equipment, processor 150 may perform operations for selecting a payment instrument in response to a user input and transmitting information on the selected payment instrument to the primary user equipment. In case of the primary user equipment, processor 150 may perform operation for receiving payment instrument information from member user equipment and transmitting the received payment instrument information and own payment instrument information to service serve 200 to make a group payment.

Processor 150 may perform operations for detecting dragging inputs to initiate setting up a group payment, to transmit the group payment information to service server 200, and to transmit the selected payment instrument information to primary user equipment. That is, processor 150 may perform operations related to the group payment service in accordance with at least one embodiment.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of making a group payment by first user equipment, the method comprising:
receiving, as a primary user equipment for a group payment, information on payment instruments from member user equipments upon generation of a predetermined event;
generating group payment information based on the received payment instrument information transmitted from the member user equipments, information on a payment instrument stored in and selected by the primary user equipment, and payment information received from a payment terminal; and
transmitting the generated group payment information to a service server for making a group payment.

2. The method of claim 1, comprising:
producing and displaying a graphic user interface that enables a user to set the first user equipment as one of a member user equipment and a primary user equipment; and
setting the first user equipment as the primary user equipment in response to a user input.

3. The method of claim 1, comprising:
producing and displaying a graphic user interface that enables a user to set the first user equipment as one of a member user equipment and a primary user equipment;
setting the first user equipment as the member user equipment in response to a user input;
selecting one of payment instruments stored in the first user equipment in response to a user input; and
transmitting the selected payment instrument information to a primary user equipment upon generation of the predetermined event.

4. The method of claim 3, wherein the predetermined event includes:
detecting the primary user equipment located in a predetermined distance; and
receiving a user input that activates a group payment service application installed in the first user equipment.

5. The method of claim 1, wherein the receiving includes:
receiving a tagging input made by each member user equipment; and
receiving payment instrument information through near field communication.

6. The method of claim 1, wherein the payment instrument information includes information on a name of a payment instrument, a payment instrument account number, an expiration date, a security code, a pin number, and an Internet address of an associated financial transaction server.

7. The method of claim 1, wherein the generating group payment information comprises:
obtaining payment information from a payment terminal upon generation of the predetermined event.

8. The method of claim 1, wherein the payment terminal information includes information on a merchant, a payment amount, a purchasing date and time, a purchased good or a service.

9. The method of claim 1, wherein the generating group payment information is initiated by receiving a dragging input that drags payment instrument icons to a group payment icon.

10. The method of claim 1, wherein the generating group payment information comprises:
receiving a user selection input for selecting at least one of the payment instrument information received from the member user equipments;
receiving a user selection input for selecting one of payment instruments stored in the primary user equipment;
generating a group payment request to include the selected payment instrument information of the member user equipments, the selected payment instrument information of the primary user equipment, the payment information from the payment terminal, and a default splitting rate.

11. The method of claim 10, wherein the generating group payment information further comprises:
displaying a graphic user interface for enabling the user to set a splitting rate for the group payment;
setting the splitting rate for the group payment in response to a user input received through the graphic user interface; and
including the splitting rate into the group payment request.

12. The method of claim 1, wherein in response to the group payment request, the service server is configured to:
request a corresponding financial transaction server to process an each split portion of a payment amount with an associated payment instrument based on information included in the group payment request;
receive a processing result from the corresponding financial transaction server; and
transmit the received processing result to the primary user equipment, the member user equipments, and the payment terminal.

13. A user equipment of making a group payment, the user equipment configured to:
receive, as a primary user equipment for a group payment, information on payment instruments from member user equipments upon generation of a predetermined event;
generate group payment information based on the received payment instrument information transmitted from the member user equipments, information on a payment instrument stored in and selected by the primary user equipment, and payment information received from a payment terminal; and
transmit the generated group payment information to a service server for making a group payment.

14. The user equipment of claim 13, wherein:
the user equipment is configured to produce and display a graphic user interface that enables a user to set the user equipment as one of a member user equipment and a primary user equipment; and
when the user equipment is set as the member user equipment in response to a user input, the user equipment is configured to select one of payment instruments stored in the first user equipment in response to a user input and to transmit the selected payment instrument information to a primary user equipment upon generation of the predetermined event.

15. The user equipment of claim 13, wherein the predetermined event includes:
detecting the primary user equipment located in a predetermined distance; and
receiving a user input that activates a group payment service application installed in the first user equipment.

16. The user equipment of claim 13, wherein:
the payment instrument information includes information on a name of a payment instrument, a payment instrument account number, an expiration date, a security code, a pin number, and an Internet address of an associated financial transaction server; and
the payment terminal information includes information on a merchant, a payment amount, a purchasing date and time, a purchased good or a service.

17. The user equipment of claim 13, wherein the user equipment is configured to obtain payment information from a payment terminal upon generation of the predetermined event.

18. The user equipment of claim 13, wherein the user equipment is configured to:
receive a user selection input for selecting at least one of the payment instrument information received from the member user equipments;
receive a user selection input for selecting one of payment instruments stored in the primary user equipment; and
generate a group payment request to include the selected payment instrument information of the member user equipments, the selected payment instrument information of the primary user equipment, the payment information from the payment terminal, and a default splitting rate.

19. The user equipment of claim 13, wherein the user equipment is configured to:
display a graphic user interface for enabling the user to set a splitting rate for the group payment;
set the splitting rate for the group payment in response to a user input received through the graphic user interface; and
include the splitting rate into the group payment request.

20. The user equipment of claim 13, wherein in response to the group payment request, the service server is configured to:
request a corresponding financial transaction server to process an each split portion of a payment amount with an associated payment instrument based on information included in the group payment request;
receive a processing result from the corresponding financial transaction server; and
transmit the received processing result to the primary user equipment, the member user equipments, and the payment terminal.
